(19) United States
(12) Patent Application Publication
(10) Pub. No.: US 2005/0073480 A1
(43) Pub. Date: Apr. 7, 2005

(54) Plasma display panel and driving method thereof

(76) Inventors: Jin-Sung Kim, Suwon-si (KR); Woo-Joon Chung, Suwon-si (KR); Kyoung-Ho Kang, Suwon-si (KR); Seung-Hun Chae, Suwon-si (KR)

Correspondence Address: MCGUIREWOODS, LLP, 1750 TYSONS BLVD, SUITE 1800, MCLEAN, VA, 22102, US

(21) Appl. No.: 10/954,247

(22) Filed: Oct. 1, 2004

(30) Foreign Application Priority Data
Oct. 1, 2003 (KR) 10-2003-0068391

(51) Int. Cl. G09G 3/28

(52) U.S. Cl. 345/60

(57) ABSTRACT

A plasma display panel (PDP) and a method for driving the PDP are described. A falling pulse waveform including alternately repeated voltage falling periods and floating periods that have a first mean slope and another falling pulse waveform including alternately repeated voltage falling periods and floating periods that have a second mean slope gentler than the first mean slope may be applied to sustain electrodes. The first and second slopes may be controlled by controlling the floating time or voltage falling range. In accordance with the present invention, it may be possible to apply pulse waveforms having diverse slopes through a simple driving circuit by floating a voltage charged in or discharged from a panel capacitor.

### CROSS REFERENCE TO RELATED APPLICATION

This application claims priority to and the benefit of Korean Patent Application No. 2003-68391 filed on Oct. 1, 2003, the entirety of which is incorporated herein by reference.

### BACKGROUND OF THE INVENTION

(a) Field of the Invention

The present invention relates to a plasma display panel (PDP) and a driving method thereof, and more particularly to a method for driving a PDP by controlling a reset waveform.

(b) Description of the Related Art

A PDP is a flat panel display that uses plasma generated by electric discharge in a gas to display characters or images. A PDP may include from several tens of thousands to millions of pixels arranged in the form of a matrix. Depending on the waveform of the driving voltage, a PDP is either a direct current (DC) PDP or an alternating current (AC) PDP. The waveform of the driving voltage will also implicitly entail differences in the discharge cell structure as well.

FIG. 1 is a perspective view illustrating a part of an AC PDP.

As shown in FIG. 1, scan electrodes 4 and sustain electrodes 5 covered with a dielectric layer 2 and a protective layer 3 may be arranged in pairs in parallel on a first substrate 1. A plurality of address electrodes 8 covered with an insulating layer 7 may be arranged on a second substrate 6. Partition walls 9 may be formed in parallel with the address electrodes 8 on the insulating layer 7 such that each partition wall 9 may be interposed between adjacent address electrodes 8. A fluorescent material 10 may be coated on the surface of the insulating layer 7 and on both sides of each partition wall 9. The first and second substrates 1 and 6 may be arranged to face each other and to define a discharge space 11 between themselves. Thus the address electrodes 8 may be orthogonal to the scan electrodes 4 and sustain electrodes 5. In the discharge space, a discharge cell 12 may be formed at an intersection between each address electrode 8 and each pair of the scan electrodes 4 and sustain electrodes 5.

FIG. 2 shows an arrangement of the electrodes in the PDP.

As shown in FIG. 2, the electrodes of the PDP may be arranged in the form of an m by n matrix. In detail, m address electrodes A1 to Am may be arranged in a column direction. Also, n scan electrodes Y1 to Yn and n sustain electrodes X1 to Xn may be alternately arranged in a row direction. Hereinafter, the scan electrodes may be referred to as “Y-electrodes”, and the sustain electrodes may be referred to as “X-electrodes”.

In accordance with a general PDP driving method, each frame of an image may be driven in a plurality of sub-fields. Each sub-field may include a reset period, an address period, and a sustain period.

In the reset period (initialization period), wall charges may be set up to erase a wall charge state in a previous sustain discharge. They also may be set up to allow a next address discharge to be carried out stably. That is, in the reset period, an optimal wall charge state may be established for an address operation in an address period following the reset period.

In the address period, cells to be turned on or off may be selected so that wall charges are accumulated in the ON cells (i.e., addressed cells). In the sustain period, a discharge occurs to actually display the image on the addressed cells.

A ramp waveform may be applied in the reset period in accordance with a conventional reset period driving method, as disclosed, for example, in U.S. Pat. No. 5,745,086. That is, conventionally, a slowly rising or falling ramp waveform may be applied to the Y-electrodes in the reset period, in order to control the wall charge at each electrode. In accordance with this reset method, however, there is a drawback in that the reset period is prolonged because the ramp waveform rises or falls slowly.

A ramp rest waveform capable of improving the reset waveform disclosed in U.S. Pat. No. 5,745,086 is disclosed in U.S. Patent Application Publication No. 2002/0075206. This ramp reset waveform is depicted in FIG. 3.

As shown in FIG. 3, in accordance with the conventional ramp reset waveform, the rising ramp reset period (or falling ramp reset period) may have a period having a sharp slope A1 (or B1), and a period having a gentle slope A2 (or B2).

In accordance with the conventional ramp reset waveform, a ramp waveform having a sharp slope may be applied in an initial portion of the reset period, in which no plasma discharge occurs, in order to achieve a reduction in reset time. Also, in a later portion of the reset period, a ramp waveform having a gentle slope may be applied, in order to stably control a reset discharge.

For implementation of the conventional reset waveform shown in FIG. 3, however, it may be necessary to apply a rising ramp waveform (or falling ramp waveform) having at least two different slopes, as mentioned above, so that there may be problems of complexity of a reset driving circuit, and an increase in costs.

### SUMMARY OF THE INVENTION

The present invention may advantageously solve the problems incurred in the related art, and may enable application of a desired reset waveform through a simple reset driving circuit.

Among other things, the present invention provides a method for driving a plasma display panel including a panel capacitor arranged between a first electrode and a second electrode. The method may include applying, in a reset period, to the first electrode, a falling pulse waveform including alternately repeated voltage falling periods and floating periods that have a first mean slope. It may also include applying, in the reset period, to the first electrode, another falling pulse waveform including alternately repeated voltage falling periods and floating periods that have a second mean slope different from the first mean slope.

The present invention also provides another method for driving a plasma display panel including a panel capacitor arranged between a first electrode and a second electrode. This method may include applying, in a reset period, to the first electrode, a rising pulse waveform including alternately repeated voltage rising periods and floating periods that have a first mean slope. This method may also include applying, in the reset period, to the first electrode, another rising pulse waveform including alternately repeated voltage rising periods and floating periods that have a second mean slope different from the first mean slope.

In accordance with another aspect, the present invention provides a plasma display panel. The panel may include a first electrode and a second electrode and a panel capacitor arranged between the first and second electrodes. The panel may also include a driving circuit adapted to apply driving signals to the first and second electrodes during a reset period. The driving circuit may apply to the first electrode a falling pulse waveform including alternately repeated voltage falling periods and floating periods to have a first mean slope. It may also apply to the first electrode another falling pulse waveform including alternately repeated voltage falling periods and floating periods to have a second mean slope gentler than the first mean slope.

The present invention also provides another plasma display panel. This panel may include a first electrode and a second electrode and a panel capacitor arranged between the first and second electrodes. The panel may also include a driving circuit to apply driving signals to the first and second electrodes during a reset period. The driving circuit may apply, to the first electrode, a rising pulse waveform including alternately repeated voltage rising periods and floating periods that have a first mean slope. The panel may also apply another rising pulse waveform including alternately repeated voltage rising periods and floating periods that have a second mean slope gentler than the first mean slope.

### BRIEF DESCRIPTION OF THE DRAWINGS

FIG. 1 is a perspective view illustrating part of a PDP.

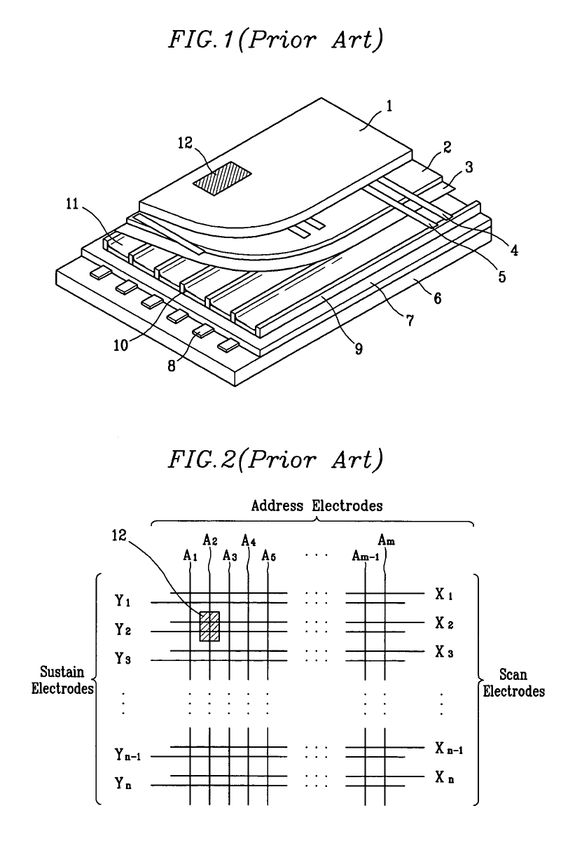

FIG. 2 is a schematic view illustrating an arrangement of electrodes in a PDP.

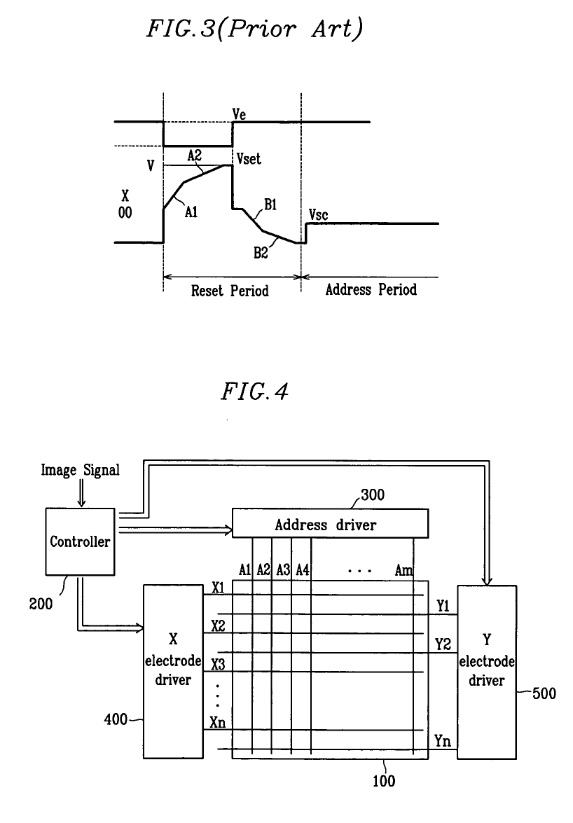

FIG. 3 is a waveform diagram illustrating a conventional reset waveform.

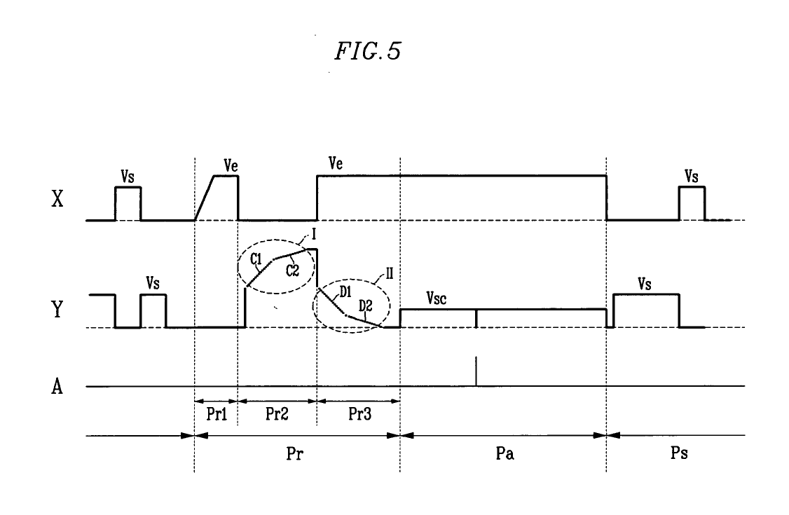

FIG. 4 is a schematic diagram of a PDP according to an exemplary embodiment of the present invention.

FIG. 5 is a waveform diagram illustrating driving waveforms according to an exemplary embodiment of the present invention.

FIGS. 6A and 6B are waveform diagrams of reset waveforms according to a first embodiment of the present invention.

FIG. 7 is a circuit diagram illustrating a circuit to drive the reset waveforms according to the first embodiment of the present invention.

FIGS. 8A and 8B are waveform diagrams of reset waveforms according to a second embodiment of the present invention.

FIGS. 9, 10, 11, 12, and 13 are circuit diagrams illustrating a circuit to drive the reset waveforms according to the second embodiment of the present invention.

### DETAILED DESCRIPTION

In the following detailed description, only certain exemplary embodiments of the present invention are shown and described, by way of illustration. The described exemplary embodiments may be modified in various ways, without departing from the present invention. Accordingly, the drawings and description are to be regarded as illustrative in nature, rather than restrictive.

In the drawings, illustrations of elements having no relation with the present invention are omitted for clarity. In the specification, the same or similar elements are denoted by the same reference numerals throughout. Also, where one element or portion is described (visually or verbally) as coupled with another element or portion, the coupling not only includes a direct coupling between the elements or portions, but also includes an indirect coupling between the elements or portion via, for example, another element or portion.

PDP driving devices and methods according to exemplary embodiments of the present invention will now be described in detail with reference to the drawings.

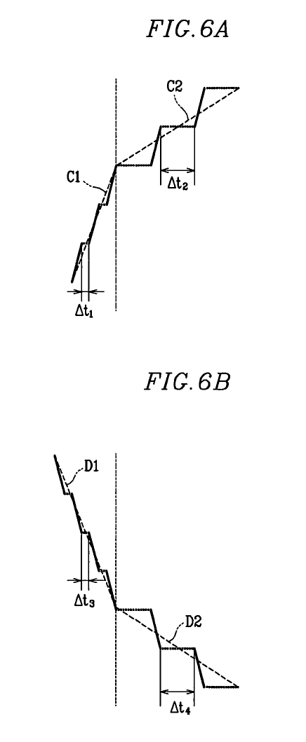

As shown in FIG. 4, the PDP may include a plasma panel 100, a controller 200, an address driver 300, a sustain electrode driver (“X-electrode driver”) 400, and a scan electrode driver (“Y-electrode driver”) 500.

The plasma panel 100 may include a plurality of address electrodes A1 to Am arranged in the column direction, a plurality of sustain electrodes (“X-electrodes”) X1 to Xn arranged in the row direction, and a plurality of scan electrodes (“Y-electrodes”) Y1 to Yn arranged in the row direction. The X-electrodes X1 to Xn may be formed such that they correspond to the Y-electrodes Y1 to Yn, respectively. In certain embodiments, the X-electrodes X1 to Xn may be coupled in common.

The controller 200 may externally receive a video signal, and may output an address driving control signal, an X-electrode driving control signal, and a Y-electrode driving control signal. In order to drive the video signal, the controller 200 may divide each frame of the video signal into a plurality of sub-fields. Each sub-field may be divided into a reset period, an address period, and a sustain period (generally in that temporal order).

The address driver 300 may receive the address driving control signal from the controller 200, and may apply display data signals to respective address electrodes A1 to Am for selecting desired discharge cells. The X-electrode driver 400 may receive an X-electrode driving control signal from the controller 200, and may apply a driving voltage to the X-electrodes X1 to Xn. The Y-electrode driver 500 may receive a Y-electrode driving control signal from the controller 200, and may apply driving voltages to respective Y-electrodes Y1 to Yn.

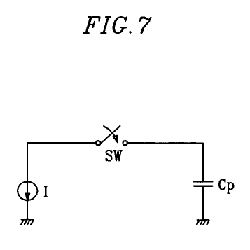

FIG. 5 is a waveform diagram illustrating driving waveforms respectively applied to the address electrodes, X-electrodes, and Y-electrodes. For convenience of illustration, only the driving waveforms applied to one address electrode, one X-electrode, and one Y-electrode are shown in FIG. 5.

As shown in FIG. 5, each sub-field may include a reset period Pr, an address period Pa, and a sustain period Ps. The reset period Pr may include an erase period Pr1, a rising period Pr2, and a falling period Pr3.

In general, positive charges may exist at the X-electrode, and negative charges may exist at the Y-electrode when the last sustain discharge of a sustain period Ps is finished. Accordingly, in the erase period Pr1 of a reset period Pr following the sustain period Ps, a ramp waveform rising from a reference voltage to a voltage Ve may be applied to the X-electrode while the Y-electrode is maintained at the reference voltage. For ease of explanation, the reference voltage is assigned the value of 0V (volts), although (of course) voltages are all relative. As a result, the charges accumulated at the X and Y-electrodes may be gradually erased.

Next, in the rising period Pr2 of the reset period Pr, a rising pulse waveform rising from a voltage Vs to a voltage Vset may be applied to the Y-electrode while the X-electrode is maintained at 0V. The “rising pulse waveform” may refer to a waveform that involves alternating repetition of voltage rising and floating waveforms. An example of the rising pulse waveform will be described further below. In accordance with an exemplary embodiment of the present invention, in an initial portion of the rising period Pr2, in which no plasma discharge occurs, a rising pulse waveform having a sharp slope C1 may be applied. In a later portion of the rising period Pr2, a rising pulse waveform having a gentle slope C2 may be applied. The expression “slope of a pulse waveform” may refer to the mean slope of the pulse waveform.

The slope of each rising pulse period can be controlled through adjustment of floating time or rising voltage variation. Thus, the control of the rising pulse slope can be implemented through a simple circuit.

When such a rising pulse is applied, weak resetting discharges may be generated between the Y-electrode and the address electrode and between the Y-electrode and the X-electrode. Thus negative charges may accumulate at the Y-electrode and positive charges may accumulate at the address electrode and the X-electrode.

In the falling period Pr3 of the reset period Pr, a falling pulse waveform falling from the voltage Vs to the reference voltage may be applied to the Y-electrode while the X-electrode is maintained at the voltage Ve. The term “falling pulse waveform” may refer to a waveform that involves alternating repetitions of voltage falling and floating. An example falling pulse waveform will be described below. In accordance with an exemplary embodiment of the present invention, in an initial portion of the falling period Pr3 (in which no plasma discharge occurs) a falling pulse waveform having a sharp slope D1 may be applied. In a later portion of the falling period Pr3, a falling pulse waveform having a gentle slope D2 may be applied. The slope of each falling pulse period can be controlled through adjustment of floating time or falling voltage variation. Thus, the control of the falling pulse slope can be implemented through a simple circuit.

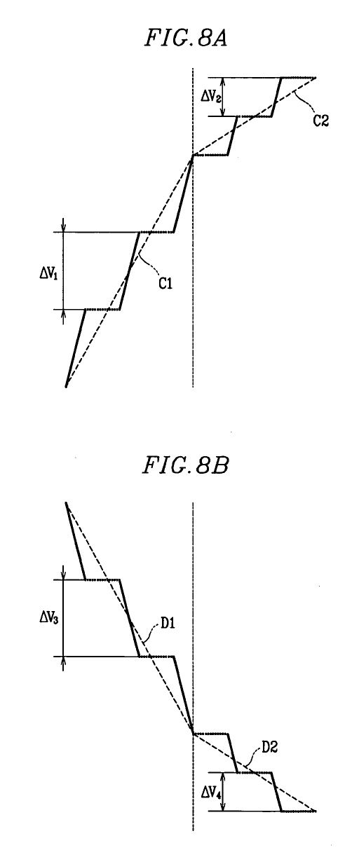

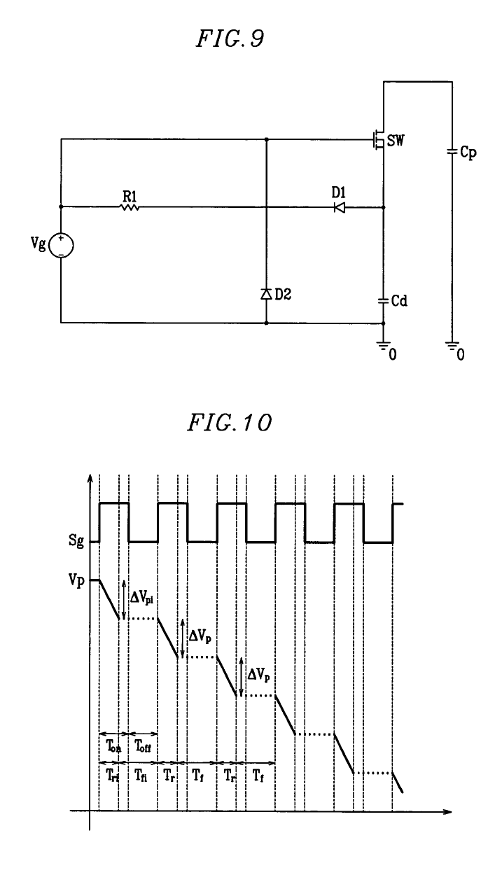

Hereinafter, a method for controlling the slope of a pulse waveform in accordance with a first embodiment of the present invention will be described with reference to FIGS. 6A, 6B and 7.

FIGS. 6A and 6B are enlarged waveform diagrams of, respectively, the rising and falling pulse waveforms shown in FIG. 5. FIG. 7 is a conceptual circuit diagram illustrating a circuit for applying pulse waveforms in accordance with the first embodiment of the present invention.

As shown in FIG. 7, a current source I adapted to supply constant current may be coupled to a panel capacitor Cp through a switch SW. In FIG. 7, the panel capacitor Cp may correspond to an equivalent circuit model of the Y and X-electrodes.

The voltage applied to a first electrode of the panel capacitor Cp when the switch SW turns on in the case of FIG. 7 may be expressed by the following Equation 1:
V=±(I/Cx)*t [Equation 1]
in which, “Cx” represents the capacitance of the panel capacitor Cp, and the sign “+” or “−” is depends on the flow direction of the current supplied from the current source I.

As may be seen from Expression 1, if the switch SW is maintained in its ON state for a predetermined time, a pulse waveform rising (or falling) with a slope of I/Cx may be applied to the first electrode of the panel capacitor Cp for the predetermined time. This may cause the first electrode to be floated for the predetermined time.

The slope of the rising pulse waveform may be controlled such that the floating period Δt1 of the rising pulse waveform having the sharp slope C1 may be set to be short. It may also be controlled such that the floating period Δt2 of the rising pulse waveform having the sharp slope C2 may be set to be long. Such an arrangement is shown in FIG. 6A. Also, the slope of the falling pulse waveform may be controlled such that the floating period Δt3 of the falling pulse waveform having the sharp slope D1 may be set to be short. Similarly it may be controlled such that the floating period Δt4 of the falling pulse waveform having the sharp slope D2 may be set to be long. Such an arrangement is shown in FIG. 6B.

In the case of FIGS. 6A and 6B, it may be preferable in terms of circuit implementation that the variation ranges of the rising and falling voltages be the same in all periods, although such uniformity is not necessarily required.

Although each of the rising and falling pulse waveforms has been described as having two slopes in conjunction with the case of FIGS. 6A and 6B, it may have an increased number of slopes and an increased number of floating periods.

Thus, it may be possible to implement a simple reset driving circuit by alternately repeating application of a rising voltage (or falling voltage) and floating while controlling the floating period to control the average slope of the pulse waveform.

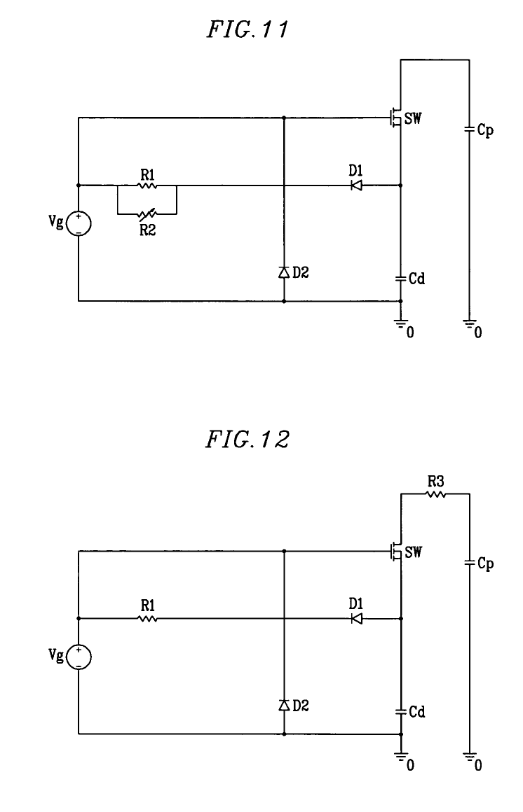

FIGS. 8A and 8B are enlarged waveform diagrams respectively illustrating the rising and falling pulse waveforms shown in FIG. 5.

In accordance with a second embodiment of the present invention, the slope of the falling pulse waveform may be controlled such that the voltage variation ΔV1 of the rising pulse waveform having the sharp slope C1 may be set to be large. Similarly, the voltage variation ΔV2 of the rising pulse waveform having the sharp slope C2 may be set to be small. Such an arrangement is shown in FIG. 8A. Also, the slope of the falling pulse waveform may be controlled such that the voltage variation ΔV3 of the falling pulse waveform having the sharp slope D1 may be set to be large. Similarly, the voltage variation ΔV4 of the falling pulse waveform having the sharp slope D2 may be set to be small. Such an arrangement is shown in FIG. 8B.

In the case of FIGS. 8A and 8B, it may be preferable in terms of circuit implementation that all floating periods be the same.

Although each of the rising and falling pulse waveforms has been described as having two slopes in conjunction with the case of FIGS. 8A and 8B, an increased number of slopes and an increased number of voltage variation ranges are permitted.

Thus, it may be possible to implement a simple reset driving circuit by alternately repeating application of a rising voltage (or falling voltage) and floating while controlling the rising voltage (or falling voltage) variation to control the slope of the pulse waveform.

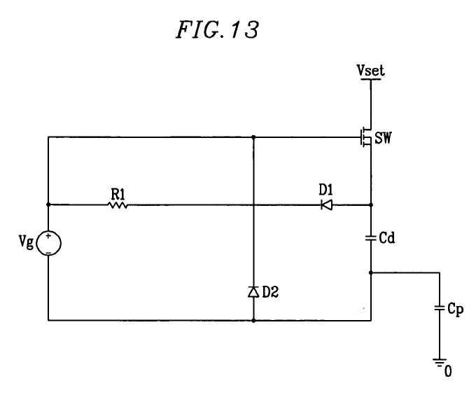

Next, a driving circuit adapted to drive a reset waveform in accordance with the second embodiment of the present invention will be described with reference to FIGS. 9 to 13. This driving circuit may, for example, be incorporated in the Y-electrode driver 500 shown in FIG. 4.

FIG. 9 illustrates an example of a driving circuit adapted to drive the pulse waveform shown in FIG. 8B. FIG. 10 is a waveform diagram illustrating a waveform driven by the driving circuit of FIG. 9.

FIGS. 11 and 12 illustrate another example of a driving circuit adapted to drive the pulse waveform shown in FIG. 8B.

In FIG. 9, panel capacitor Cp may be a capacitive load formed between the Y-electrode and the X-electrode. A ground voltage may be applied to a second end of the panel capacitor Cp. The panel capacitor Cp may be charging with a predetermined amount of charges.

The driving circuit shown in FIG. 9 may include a transistor SW, a capacitor Cd, a resistor R1, diodes D1 and D2, and a control signal voltage source Vg. The transistor SW may be coupled at its drain to a first end of the panel capacitor Cp, and at its source to a first end of the capacitor Cd. The capacitor Cd may be coupled at its second end to the ground O. The control signal voltage source Vg may be coupled between the gate of the transistor SW and the ground O to supply a control signal Sg to the transistor SW.

The diode D1 and resistor R1 may be coupled between the first end of the capacitor Cd and the control signal voltage source Vg to establish a discharge path allowing the capacitor Cd to be discharged. The diode D2 may be coupled between the ground O and the gate of the transistor SW to, for example, clamp the gate voltage of the transistor SW. Although not shown, an additional resistor may be coupled between the control signal voltage source Vg and the transistor SW. Another resistor may be coupled between the gate of the transistor SW and the ground O.

Next, operation of the driving circuit shown in FIG. 9 will be described with reference to FIG. 10.

As shown in FIG. 10, the control signal Sg (which may be supplied from the control signal voltage source Vg) has a voltage varying alternately between a high level to turn on the transistor SW and a low level to turn off the transistor SW.

When the transistor SW is turned on by the control signal Sg (which may have a high voltage level) charges accumulated in the panel capacitor Cp may be moved to the capacitor Cd. As the moved charges are accumulated in the capacitor Cd, the first end voltage of the capacitor Cd may rise, causing the source voltage of the transistor SW to rise. The gate voltage of the transistor SW may be maintained at the voltage that was present when the transistor SW was turned on. However, the first end voltage of the capacitor Cd may rise as compared to the second end voltage of the capacitor Cd. Therefore, the source voltage of the transistor SW may rise as compared to the gate voltage of the transistor SW. When the source voltage of the transistor SW rises to a predetermined voltage, the voltage between the gate and the source (“the gate-source voltage”) of the transistor SW may be lower than a threshold voltage Vₜ of the transistor SW, and the transistor SW may be turned off.

That is, the transistor SW may be turned off when the difference between the high level voltage of the control signal Sg and the source voltage of the transistor SW is lower than the threshold voltage Vₜ of the transistor SW. When the transistor SW is turned off, the voltage supplied to the panel capacitor Cp may be cut off, and the panel capacitor Cp may be floated. The amount of charges ΔQᵢ accumulated in the capacitor Cd when the transistor SW is turned off may be expressed by the following Equation 2:
ΔQᵢ=C_{d}(V_{cc}−Vₜ) [Equation 2]
in which, “V_{cc}” may represent the high level voltage of the control signal Sg, “Vₜ” may represent the threshold voltage of the transistor SW, and “C_{d}” may represent the capacitance of the capacitor Cd.

If the capacitance C_{d} of the capacitor Cd is appropriately set, the voltage falling period Tᵣᵢ of the panel capacitor Cp can be shorter than the high level period Tₒₙ of the control signal Sg. That is, the panel capacitor Cp can be floated faster than if the panel capacitor Cp is floated through the level control for the control signal Sg. Also, the floating period T_{fi} can be longer than the falling voltage applying period Tᵣᵢ because the transistor SW has already been maintained in its OFF state when the control signal Sg becomes a low level voltage to turn off the transistor SW.

The voltage reduction ΔVₚᵢ of the panel capacitor Cp may be expressed by the following Equation 3 because the amount of charges ΔQᵢ accumulated in the capacitor Cd may be supplied from the panel capacitor Cp.

$$Δ {V}_{pi} = \frac{Δ {Q}_{i}}{{C}_{p}} = \frac{{C}_{d}}{{C}_{p}} ( {V}_{cc} - {V}_{t} ) \qquad [ Equation 3 ]$$

in which, “Cₚ” may represent the capacitance of the panel capacitor Cp.

Next, when the control signal becomes a low level voltage, the capacitor Cd may be discharged through the discharge path established through the capacitor Cd, diode D1, resistor R1 and control signal voltage source Vg because the first end voltage of the capacitor Cd may be higher than the voltage supplied from the control signal voltage source Vg. Since the capacitor Cd may be discharged when it has been charged to a voltage corresponding to “Vcc−Vt”, the voltage reduction ΔV_{d} of the capacitor Cd caused by the discharge may be expressed by

$$Δ {V}_{d} = ( {V}_{cc} - {V}_{t} ) {ⅇ}^{- \frac{1}{{R}_{1} {C}_{d}} t} \text{:} \qquad Equation 4$$

in which R₁ may be the resistance of the resistor R1.

In addition, the amount of charges ΔQ_{d} discharged from the capacitor Cd can be expressed by Equation 5 in terms of the low level time T_{off} of the control signal Sg. Similarly, the amount of charges Q_{d} remaining in the capacitor Cd can be expressed by Equation 6.

$$\begin{matrix}Δ {Q}_{d} = {C}_{d} ( {V}_{cc} - {V}_{t} ) - {C}_{d} ( {V}_{cc} - {V}_{t} ) {ⅇ}^{- \frac{1}{{R}_{1} {C}_{d}} {T}_{off}} \\ = {C}_{d} ( {V}_{cc} - {V}_{t} ) ( 1 - {ⅇ}^{- \frac{1}{{R}_{1} {C}_{d}} {T}_{off}} )\end{matrix} \qquad [ Equation 5 ]$$

Q_{d}=ΔQᵢ−ΔQ_{d} [Equation 6]

Next, when the control signal Sg returns to the high level voltage, the transistor SW may be turned on. Thus, charges from the panel capacitor Cp may be moved to the capacitor Cd. As described above, the transistor SW may be turned off when the capacitor Cd is charged to the charge amount ΔQᵢ. Therefore, the transistor SW may be turned off when the charges ΔQᵢ are moved from the panel capacitor Cp to the capacitor Cd. As a result, the voltage reduction ΔVₚ of the panel capacitor Cp can be expressed by Equation 7.

$$Δ {V}_{p} = \frac{Δ {Q}_{d}}{{C}_{p}} = \frac{{C}_{d}}{{C}_{p}} ( {V}_{cc} - {V}_{t} ) ( 1 - {ⅇ}^{- \frac{1}{{R}_{1} {C}_{d}} {T}_{off}} ) \qquad [ Equation 7 ]$$

As described above, when the voltage of the panel capacitor Cp is reduced by ΔVₚ, the voltage of the capacitor Cd may rise, thereby causing the transistor SW to turn off. When the control signal Sg becomes the low level voltage, the capacitor Cd may be discharged while the transistor SW is maintained in its OFF state. Thus, the voltage falling period Tr (for which the voltage of the panel capacitor Cp falls in response to the high voltage level of the control signal Sg) and the floating period Tf (for which the panel capacitor Cp is floated in accordance with an increase in the voltage of the capacitor Cd) may be alternately repeated. Accordingly, a falling pulse waveform involving alternating repetitions of voltage falling and floating can be applied to the electrodes.

As shown in Equation 7, it can be seen that the falling voltage of the panel capacitor Cp may be determined by the resistance of the resistor R1 and the low level period T_{off} of the control signal Sg. Accordingly, the voltage reduction range of the panel capacitor Cp can be controlled based on the duty of the control signal Sg and the resistance of the resistor R1. For example, the voltage reduction range can be increased by increasing the resistance of the resistor R1 or the low level period T_{off}. Thus, the sharp slope can be controlled.

The driving circuit shown in FIG. 9 may be adapted to control the slope of the falling pulse by appropriately determining the low level period T_{off}, based on Equation 7. Specifically, the driving circuit of FIG. 9 may set the low level period such that the low level is period may be long in the periods having a sharp slope while being short in the periods having a gentle slope.

Although the discharge path in the driving circuit shown in FIG. 9 may be coupled to the control signal voltage source Vg in order to alternately repeat voltage falling and floating, the discharge path may be established along another route not coupled to the control signal voltage source Vg. For example, a switching element may be coupled between the first end of the capacitor Cp and the ground O to establish a discharge path. In such a case, the switch element may be turned on for the discharge period T_{off} of the capacitor Cp.

FIG. 11 illustrates another example of a driving circuit adapted to drive the pulse waveform shown in FIG. 8B.

Elements of the driving circuit shown in FIG. 11 respectively corresponding to those of FIG. 9 are designated by the same reference numerals. The driving circuit of FIG. 11 may be substantially identical to the driving circuit of FIG. 9, except that a variable resistor R2 may be coupled to the resistor R1 in parallel.

One reason why the variable resistor R2 may be added in the driving circuit of FIG. 11 may be to control the voltage reduction range of the panel capacitor Cp through adjustment of the resistance of the resistor R1 (actually the resistance of the parallel combination of resistor R1 and resistor R2) expressed in Equation 7. That is, the voltage reduction range of the panel capacitor Cp can be controlled by adjusting the resistance of the variable resistor R2. Of course, the variable resistor R2 may be replaced for the resistor R1 without being coupled to the resistor R1 in parallel. In other words, resistor R1 may itself be a variable resistor, and such an arrangement should be viewed as equivalent.

FIG. 12 is another example of a driving circuit adapted to drive the pulse waveform shown in FIG. 8B.

Elements of the driving circuit shown in FIG. 12 respectively corresponding to those in FIG. 9 are designated by the same reference numerals. The driving circuit of FIG. 12 may be substantially identical to the driving circuit of FIG. 9, except that a resistor R3 may be coupled between the transistor SW and the panel capacitor Cp.

The resistor R3 may be adapted to limit the amount of current discharged from the panel capacitor Cp. Instead of the resistor R3, other elements that limit the amount of current may be used. For example, an inductor (not shown) may be used.

FIG. 13 is an example of a driving circuit adapted to drive the waveform shown in FIG. 8A. The driving circuit of FIG. 13 may be substantially identical to the driving circuit of FIG. 9, except that the capacitor Cd may not be coupled to the ground voltage, but instead may be coupled to the panel capacitor Cp. Also, the drain of the transistor S3 may be coupled to a voltage Vset. Those skilled in the art may easily appreciate the operation of the driving circuit shown in FIG. 13, by comparing the description given in conjunction with FIGS. 9 and 10. Accordingly, no additional description has been provided regarded the operation of this specific driving circuit.

In accordance with the present invention, it may be possible to apply pulse waveforms having diverse slopes through a simple driving circuit by floating a voltage charged in or discharged from a panel capacitor.

While this invention has been described in connection with certain exemplary embodiments, it is to be understood that the invention is not limited to the disclosed embodiments.

1. A method for driving a plasma display panel comprising a panel capacitor arranged between a first electrode and a second electrode, comprising:
applying, in a reset period, to the first electrode, a falling pulse waveform comprising alternately repeated voltage falling periods and floating periods that have a first mean slope; and
applying, in the reset period, to the first electrode, another falling pulse waveform comprising alternately repeated voltage falling periods and floating periods that have a second mean slope different from the first mean slope.

2. The method of claim 1, wherein the second mean slope is less than the first mean slope.

3. The method of claim 1, wherein each of the first and second mean slopes is controlled by adjusting the floating periods or voltage falling range in the voltage falling periods associated therewith.

4. The method of claim 1, wherein the application of the falling pulse waveform having the second mean slope follows the application of the falling pulse waveform having the first mean slope.

5. A method for driving a plasma display panel comprising a panel capacitor arranged between a first electrode and a second electrode, comprising:
applying, in a reset period, to the first electrode, a rising pulse waveform comprising alternately repeated voltage rising periods and floating periods to have a first mean slope; and
applying, in the reset period, to the first electrode, another rising pulse waveform comprising alternately repeated voltage rising periods and floating periods to have a second mean slope different from the first mean slope.

6. The method of claim 5, wherein the second mean slope is less than the first mean slope.

7. The method of claim 5, wherein each of the first and second mean slopes is controlled by adjusting the floating period or a voltage rising range in the voltage rising periods associated therewith.

8. The method of claim 5, further comprising:
applying, in a reset period, to the first electrode, a falling pulse waveform comprising alternately repeated voltage falling periods and floating periods that have a third mean slope; and
applying, in the reset period, to the first electrode, another falling pulse waveform comprising alternately repeated voltage falling periods and floating periods that have a fourth mean slope gentler than the third mean slope.

9. A method for driving a plasma display panel comprising a panel capacitor arranged between a first electrode and a second electrode, comprising a pulse waveform comprising alternately repeated voltage application periods and floating periods with at least two different mean slopes applied to the first electrode in a reset period.

10. A plasma display panel, comprising:
a first electrode and a second electrode;
a panel capacitor arranged between the first and second electrodes; and
a driving circuit to apply driving signals to the first and second electrodes during a reset period;
wherein the driving circuit applies to the first electrode a falling pulse waveform comprising alternately repeated voltage falling periods and floating periods that have a first mean slope, and another falling pulse waveform comprising alternately repeated voltage falling periods and floating periods that have a second mean slope less steep than the first mean slope.

11. The plasma display panel of claim 9, wherein the driving circuit comprises:
a current source; and
a switch coupled between the current source and the first electrode.

12. The plasma display panel of claim 9, wherein the driving circuit controls the first and second mean slopes by adjusting the floating periods or a voltage falling range in the voltage falling periods associated therewith.

13. The plasma display panel of claim 12, further comprising:
a transistor coupled, at a first main terminal thereof, to the panel capacitor;
a second capacitor coupled, at a first end thereof, to a second main terminal of the transistor; and
a control voltage source adapted to supply a control voltage to a control terminal of the transistor;
wherein the transistor has a state determined by a voltage at the first end of the second capacitor.

14. The plasma display panel of claim 13, further comprising:
a discharge path coupled, at a first end thereof, to the first end of the second capacitor,
wherein the plasma display panel has a discharge period, for which a voltage at a second end of the discharge path is lower than the voltage at the first end of the second capacitor.

15. The plasma display panel of claim 14, wherein the discharge path comprises:
a diode forwardly coupled between the first end of the second capacitor and a second end of the discharge path.

16. The plasma display panel of claim 14, wherein the discharge path further comprises a variable resistor.

17. The plasma display panel of claim 16, wherein the driving circuit controls the first and second mean slopes by adjusting a resistance of the variable resistor.

18. The plasma display panel of claim 14, wherein the discharge path is coupled, at a second end thereof, to the control voltage source.

19. The plasma display panel of claim 18, wherein:
the control voltage comprises alternate first and second voltages;
the first voltage is a voltage enabling the transistor to be turned on when the second capacitor is discharged in a predetermined discharge amount through the discharge path; and
the second voltage is a voltage lower than the voltage at the first end of the second capacitor during the discharge of the capacitor.

20. The plasma display panel of claim 19, wherein the driving circuit controls the first and second mean slopes by adjusting a period of the second voltage.

21. The plasma display panel of claim 13, further comprising:
a resistor or inductor coupled between the panel capacitor and the first main terminal of the transistor.

22. A plasma display panel, comprising:
a first electrode and a second electrode;
a panel capacitor arranged between the first and second electrodes; and
a driving circuit adapted to apply driving signals to the first and second electrodes during a reset period, respectively;
wherein the driving circuit applies, to the first electrode, a rising pulse waveform comprising alternately repeated voltage rising periods and floating periods that have a first mean slope, and another rising pulse waveform comprising alternately repeated voltage rising periods and floating periods that have a second mean slope of lower magnitude than the first mean slope.

23. The plasma display panel of claim 22, wherein the driving circuit applies, to the first electrode, a falling pulse waveform comprising alternately repeated voltage falling periods and floating periods that have a third mean slope, and another falling pulse waveform comprising alternately repeated voltage falling periods and floating periods that have a fourth mean slope of lower magnitude than the third mean slope.

24. The plasma display panel of claim 22, wherein the driving circuit controls the first and second mean slopes by adjusting the floating periods or a voltage rising range in the voltage rising periods associated therewith.
